(19) United States
(12) Patent Application Publication
(10) Pub. No.: US 2007/0014281 A1
(43) Pub. Date: Jan. 18, 2007

(54) Voice call continuity application server between IP-CAN and CS networks

(75) Inventor: Nishi Kant, San Jose, CA (US)

Correspondence Address: GROOVER & HOLMES, BOX 802889, DALLAS, TX, 75380-2889, US

(73) Assignee: Azaire Networks

(21) Appl. No.: 11/454,184

(22) Filed: Jun. 15, 2006

Related U.S. Application Data
(60) Provisional application No. 60/690,843, filed on Jun. 15, 2005.

(51) Int. Cl. H04L 12/66; H04L 12/56

(52) U.S. Cl. 370/352; 370/401

(57) ABSTRACT

A system and method for continuous voice calls when a user switches between packet data and circuit switched access networks. In one example embodiment, the present innovations include an interworking system that supports voice call continuity for a user that moves between IP-CAN and CS networks (e.g., PSTN or GSM). In one example embodiment, the present innovations comprise a voice call continuity application server (VCC-AS) that serves as an anchor point for a voice call (i.e., it is the node from which a handover is initiated) and controls and handles voice calls to and from the user equipment (UE) regardless of the access network.

### CROSS-REFERENCE TO RELATED APPLICATIONS

This application claims priority from U.S. provisional patent application 60/690,843, titled “Voice Call Continuity Application Server between IP-CAN and CS Networks,” filed on Jun. 15, 2005, which is hereby incorporated by reference.

### BACKGROUND AND SUMMARY OF THE INVENTION

1. Field of the Invention

The present inventions relate generally to wireless telephony, and more particularly to use of multiple wireless access networks while maintaining call continuity.

2. Description of Background Art

The present invention relates to convergent interworking of voice and data service between IP-connectivity access network (IP-CAN, e.g. WLAN) and GSM CS networks. As the data convergence between IP-CAN and cellular networks becomes more and more prevalent, it is beneficial for the operators to have the capability to support voice service over IP-CAN as well. Moreover since the end user devices are likely to have both accesses, it is also important to have voice continuity across these accesses. Specifically the end user must be able to originate calls and accept calls as long as the user is in one of the valid access networks and the call should continue when user moves across access boundaries.

Currently the data convergence service between IP-CAN and GSM/GPRS network is being widely deployed and provided. These technologies depend on the data side, where both the GPRS and IP-CAN domain provide the service over IP. Even though the underlying networks are different, the application layer has the common transport layer, e.g. IP, so a node can control the handover process between two accesses. Various mechanisms can be used at this node to provide the data handover, including mobile IP or Gn-like handover mechanism. However, these methods cannot be readily applied to voice case because the voice call for CS network is carried over ISUP while the voice call for IP-CAN is carried over IP using RTP. Also, since the call bearer and call control path are different, there should be a mechanism to identify the UE's current serving domain (CS network or IP-CAN), to properly handle the call according to the serving domain, and to hand-over the call without voice disruption.

In order to achieve the above, there should be an interworking system that supports voice call continuity between IP-CAN and CS network (e.g. PSTN or GSM). The system becomes the anchor point of the voice call and controls and handles all the voice calls to and from the UE regardless of the access network, so that the voice service can be provided whether the UE is accessible through the IP-CAN or the CS network, or whether the call is destined/originated to and from CS network or IP network. With this system, the GSM service providers can offer the voice call continuity as well as data service continuity between IP-CAN (e.g. WLAN) and legacy networks (e.g. GSM).

Access networks reside between the user equipment and the core network. It performs functions specific to the particular access technique being used. In the case of UMTS, for example, the access network performs functions specific to the access of WCDMA air interface. The core network, on the other hand, may be used with any access technique. This functional split between the core network and the access network provides the flexibility to keep the core network fixed while allowing the access technique to change.

A 3G core network typically handles two types of traffic, namely, voice and data traffic, using two domains: the circuit switched (CS) domain and the packet switched (PS) domain. The CS domain normally provides services related to voice transfer, and the PS domain provides services related to data transfer.

The CS domain uses circuit switched connections for communication between the UE and the destination. A CS connection is defined as a connection for which dedicated network resources are allocated at the time the connection is established and are freed when the connection is released. An example of a CS connection is the PSTN network used in normal telephone conversations.

The PS domain uses packet switched connections for communication between the UE and the destination. A PS connection is defined as a connection that transports the user information using autonomous concatenation of bits called packets; each packet is routed independently from the previous one. The resources of a PS connection are not reserved for a connection; rather, they are shared between various communicating entities. This sharing results generally in better resource use. An example of a PS connection is the transfer of IP data on the Internet.

### Voice Call Continuity Application Server Between IP-CAN and CS Networks

The present innovations include an interworking system that supports voice call continuity for a user that moves between IP-CAN and CS networks (e.g., PSTN or GSM). In one example embodiment, the present innovations comprise a voice call continuity application server (VCC-AS) that serves as an anchor point for a voice call (i.e., it is the node from which a handover is initiated) and controls and handles voice calls to and from the user equipment (UE) regardless of the access network.

In preferred embodiments, the voice data is carried in VoIP form in the IP-CAN and converted to an appropriate form when delivered to the CS network. The VCC-AS preferably maintains two separate legs of a call, with itself serving as anchor. When a user roams, for example, from an IP-CAN into a GPRS access network, the VCC-AS terminates the call leg between itself and the UE through the IP-CAN and establishes a call leg between itself and the UE through the new access network (i.e., the GPRS access network). This changing of call legs can include changes in bearers.

In preferred embodiments, one or more different types of call bearer can be used. For example, when a GPRS access network is used by the UE to connect to a CS network, one or more CS bearers are used throughout the call. When an IP-CAN is used by the UE, one or more packet data network bearers (e.g., RTP bearer) are used for part of the call (e.g., between the UE and media gateway), while one or more CS bearers are used for the rest of the call (e.g., between the media gateway and the CS network).

The present innovations are preferably applicable whether the UE initiates a call or whether the call is initiated from elsewhere toward the UE.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 shows a network system architecture consistent with an embodiment of the present innovations.

FIG. 2 shows a protocol stack for voice call control in WLAN mode consistent with an embodiment of the present innovations.

FIG. 3 shows a protocol stack for voice call bearer in WLAN mode consistent with an embodiment of the present innovations.

FIG. 4 shows a protocol stack for voice call control in GSM mode consistent with an embodiment of the present innovations.

FIG. 5 shows a converged user equipment consistent with an embodiment of the present innovations.

FIG. 6 shows a mobile originating call flow for WLAN mode consistent with an embodiment of the present innovations.

FIG. 7 shows a mobile originating call flow in GSM mode consistent with an embodiment of the present innovations.

FIG. 8 shows a mobile terminating call flow in WLAN mode consistent with an embodiment of the present innovations.

FIG. 9 shows a mobile terminating call flow in GSM mode consistent with an embodiment of the present innovations.

FIG. 10 shows handover call flow for WLAN to GSM consistent with an embodiment of the present innovations.

FIG. 11 shows handover call flow from GSM to WLAN consistent with an embodiment of the present innovations.

### DETAILED DESCRIPTION OF THE PREFERRED EMBODIMENTS

The numerous innovative teachings of the present application will be described with particular reference to the presently preferred embodiment (by way of example, and not of limitation).

The present innovations include, in various embodiments, an interworking system that supports voice call continuity for a user that moves between different access networks, such as IP-CAN and CS access networks (e.g., PSTN or GSM). In one example embodiment, the present innovations comprise a voice call continuity application server (VCC-AS) that serves as an anchor point for a voice call (i.e., it is the node form which a handover is initiated) and controls and handles voice calls to and from the user equipment (UE) regardless of the access network.

In preferred embodiments, the voice data is carried in VoIP form in the IP-CAN and converted to an appropriate form when delivered to the CS network. The VCC-AS preferably maintains two separate legs of a call, with itself serving as anchor. When a user roams, for example, from an IP-CAN into a GPRS access network, the VCC-AS terminates the call leg between itself and the UE through the IP-CAN and establishes a call leg between itself and the UE through the new access network (i.e., the GPRS access network). This changing of call legs can include changes in bearers.

In preferred embodiments, one or more different types of call bearer can be used. For example, when a GPRS access network is used by the UE to connect to a CS network, one or more CS bearers are used throughout the call. When an IP-CAN is used by the UE, one or more packet data network bearers (e.g., RTP bearer) are used for part of the call (e.g., between the UE and media gateway), while one or more CS bearers are used for the rest of the call (e.g., between the media gateway and the CS network).

The present innovations are preferably applicable whether the UE initiates a call or whether the call is initiated from elsewhere toward the UE.

In preferred embodiments, the present innovations provide the mechanism to offer voice call continuity between IP-CAN and CS network through VCC-AS and converged UE. The VCC-AS resides in the operator's IMS domain and is responsible for managing VoWLAN (Voice over WLAN) and VoIP. The Application Server (AS) concept is exploited to manage control of GSM-CS and VoWLAN inter-working scenarios. The VCC-AS handles all the calls to and from the converged UE whether the UE is in CS (e.g., GSM) mode or IP-CAN (e.g., WLAN) mode. In some embodiments, the converged UE provides integrated control over different radio access so that all the calls can be handled using appropriate radio access. The call towards the external telephone network is anchored at the VCC-AS and its decision to handover from one access technology to another is transparent to the calling and called parties. Specifically, there are always at least two signaling legs, one from UE to VCC-AS and the other from VCC-AS to the other party residing in PSTN, PLMN, or PDN.

In general terms a call leg can be described as combination of media and signaling. In GSM, for traditional CS call, both signaling and media path are the same between UE and the MSC (Mobile Switching Center). In IP networks these are typically different. The present innovations preferably separate signaling and bearer for the call leg even when UE is in GSM access network. It is the call signaling legs that are separated into two parts by VCC-AS. VCC-AS acts as B2BUA and a static anchor point for all the calls, so that the VCC-AS can control the calling or called legs transparently without disrupting the on-going call bearer. The prevalent VoIP signaling protocol SIP can be used for all the call control at VCC-AS. The registration of the UE to the VCC-AS preferably occurs through SIP registration. There are several ways to provide the access domain information of the UE to the VCC-AS through SIP registration, and it can be optimized at actual implementation.

When UE is in WLAN mode, the SIP signaling is preferably carried over conventional IP to VCC-AS and the SIP signal indicates that the user is in WLAN mode. When the UE is in GSM mode, the SIP signaling is preferably carried over out-of-band auxiliary data channel such as GPRS, USSD, or even SMS to VCC-AS and the SIP signal indicates that the user is in GSM mode. The circuit switched bearer is used for media as in the traditional case when the user is in GSM mode.

This registration preferably happens whenever the user obtains the access to the specific access network, e.g., IP-CAN or GSM CS network. In other words, the registration may happen at power-on, roaming, or handover. On handover, handover mechanism may provide the mechanism to identify the access network and the registration process may be skipped or may be different from normal registration process. Where both access networks are available, the decision to which domain the user would be registered is based on various criteria such as user preference, signal strength, QoS, or the operator's policy, etc.

In one example embodiment, when a UE is in IP-CAN (WLAN) mode, mobile originating (MO) calls from a WLAN cell makes the converged UE initiate a SIP call control session over the 3GPP/WLAN interworking functions (TTG) and the GPRS network (GGSN) to the VCC-AS. The IMS routing nodes (e.g. S-CSCF) need to have some logic to route all the MO calls to VCC-AS. If the destination party is in PSTN or PLMN, the VCC-AS initiates another signaling leg through MGCF/SGW towards the destination party, acting as a B2BUA. After MGCF/SGW exchanges the ISUP call control signaling with the destination in CS network (PSTN or GSM), it forwards the result to the VCC-AS, and the voice call is delivered through UE-TTG/GGSN-MGW-Destination path. The signal is anchored at VCC-AS and the bearer is anchored at MGW. When the destination party is in PDN, the VCC-AS initiates another signaling leg directly to the destination party, acting as B2BUA. The voice call is delivered through UE-TTG/GGSN-destination path. No signaling conversion is needed in this case. In another example embodiment, when a UE is in CS mode, mobile originating (MO) calls from a GSM cell will initiate a SIP call control session over the GPRS network (through GPRS bearer, USSD, or SMS) to the VCC-AS. This SIP call control session is initiated through converged UE's integrated control, i.e. IMC. Since VCC-AS keeps track of the registration mode for the UE (i.e. IP-CAN mode or CS mode) through SIP registration that had occurred beforehand, when a SIP MO call control message arrives at VCC-AS and the UE is in CS mode, it instructs the UE and MGW to add CS bearer through SIP signaling. Thus the CS call leg between UE and the VCC-AS is established. VCC-AS then initiates the second leg of the signaling toward the destination number as in the case when UE is in WLAN mode.

In another example implementation, all the MT calls to convergence subscribers arrive at VCC-AS. Some logic would be required at the IMS routing node (e.g. S-CSCF) and GSM switching node (e.g. MSC) to route the calls to VCC-AS. When VCC-AS receives a call, it determines if the UE is registered in IP-CAN (WLAN) or CS network (GSM). If it is registered in IP-CAN, the VCC-AS acts as B2BUA and creates another SIP session toward the destination. If it is registered in CS network, VCC-AS terminates this leg and initiates another signaling leg between VCC-AS and UE, acting as B2BUA. When initiating the second leg, VCC-AS can act in two ways. It would either initiate an SIP session toward the UE instructing it to add CS bearer towards the serving MSC or initiate a SIP session toward the serving MSC of the UE instructing it to add CS bearer towards the UE. It is upon implementation decision which method is optimal for the given environment.

VCC-AS is responsible for the handover between IP-CAN and CS network so that if a user was in the middle of a voice call when the access network is changed, the voice call can be continued without disruption. This seamless handover is achieved by virtue of the fact that the call towards the external entity is anchored at the VCC-AS and that the VCC-AS is capable of initiating call signaling legs to UE over different access networks while maintaining the leg with the external entity. The VCC-AS is capable of switching between the two bearers based on signaling from the UE; i.e. if the UE sees IP-CAN network as the best bearer it would signal this information to VCC-AS and the IP-CAN would be used as the bearer through VCC-AS's instruction. Similarly, the UE would signal to the VCC-AS to switch to GPRS/UMTS if the UE decides that the GPRS/UMTS is the best bearer under current circumstances. Through this mechanism, the VCC-AS is aware of the access network change and controls all the call-related signaling.

As one advantage of the present innovations, the voice call is highly likely to continue when the UE moves across the CS network or the IP-CAN network, thereby switching access networks. The VCC-AS controls all the call signaling and converged UE provides the integrated control over the calls.

The following examples are offered by way of illustration, not limitation.

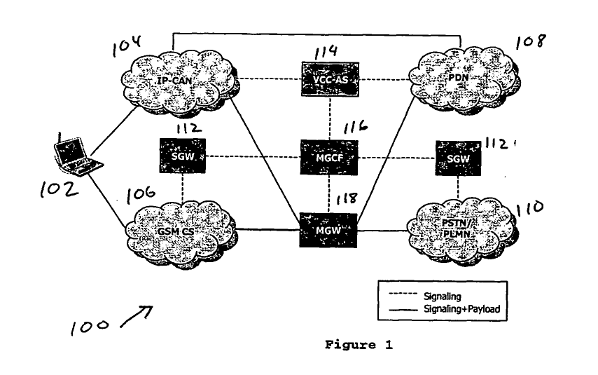

FIG. 1 shows one example system architecture 100 consistent with use of the Voice call continuity application server (VCC-AS) 114. PSTN 110 is the legacy public telecommunications network mainly used to carry voice traffic. PLMN is the land mobile communications network mainly used to carry voice traffic, for example GSM CS network. PSTN and PLMN together represent the circuit switched network where the voice call is delivered using CS technology, e.g. ISUP.

The GSM is the standard cellular system using TDMA technology, and includes all the functional/physical nodes to provide the service, which is comprised of radio access network and core network nodes. Here it is assumed that the GSM network includes the GPRS network through which the data service is provided.

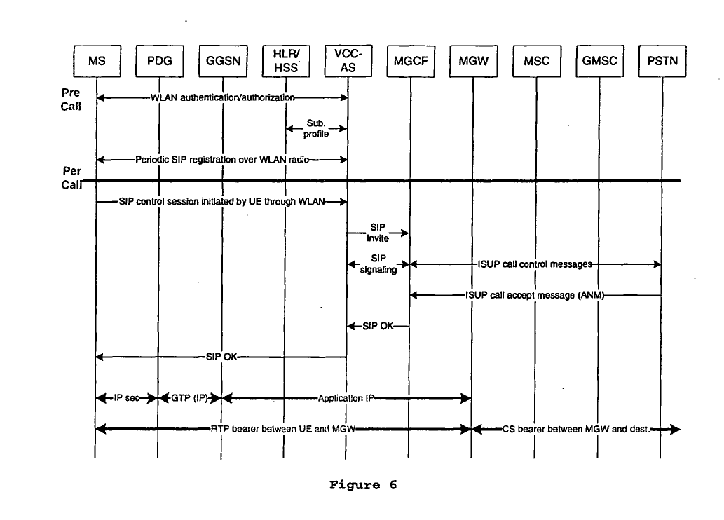

PDN 108 is the packet-switched data network mainly used to carry data traffic, for example public IP network or IMS. Usually the IP protocol is used as network layer protocol in PDN 108. IP-CAN 104 is any generic access network that can provide the IP connectivity, e.g. WLAN. When IP-CAN 104 is WLAN, a gateway node such as a PDG (packet data gateway; see FIGS. 6-11) is used to connect the WLAN and the PDN 108. PDG is responsible for routing the packet data between UE 102 and PDN 108 through WLAN, assigning or relaying of remote IP address, establishing secure tunnel between UE and itself, and performing the encapsulation and de-capsulation. GGSN is the anchor point for the packet traffic for the 3GPP UE. All the packet data is delivered through GGSN. For 3GPP-WLAN interworking service, PDG can also play the role of GGSN to route the traffic to and from the PDN, or only terminate the secure tunnel between UE and itself, acting as TTG (Tunnel terminating gateway). When PDG is working as TTG, it sends all the payload and signaling through GGSN. SGW (Signaling gateway) 112 is located between CS network (PSTN, PLMN 110) and the IP network and is responsible for converting the transport layer signaling between IP network and SS7 network.

MGCF (Media gateway control function) 116 is responsible for assigning the appropriate resource for the traffic and controlling the MGW 118. It also converts the call control messages between CS network (e.g. ISUP messages) and IP network (e.g. SIP).

MGW (Media gateway) 118 is responsible for switching the traffic between circuit and packet-switched network. MGW 118 converts the voice call stream between RTP packets and TDM stream so that the voice call interworking between IP and CS network is possible. The MGW 118 connects all the network clouds for converting the call bearer traffic.

The VCC-AS 114 is acting as the anchoring point and responsible for all the call control, mobility management, and handover between IP-CAN 104 and GSM CS 106 networks. All the calls to and from the UE 102 arrive at VCC-AS 114 for handling and routing as if the call destination is the VCC-AS 114. Then according to the user registration domain and the destination, VCC-AS 114 initiates another call leg to the destination through appropriate radio access. Since VCC-AS 114 sits between IP-CAN and GSM network and handles all the calls, VCC-AS 114 has the control of the call and hands over the call while the user is moving across the access domain.

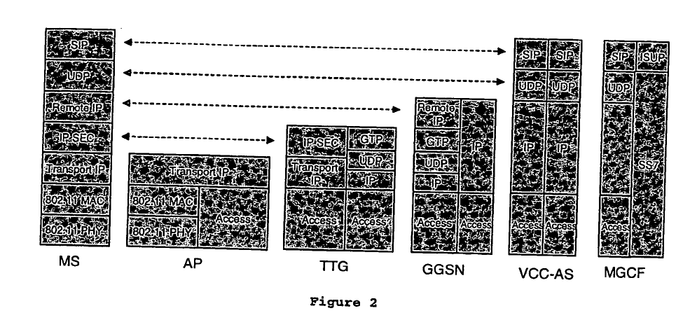

FIG. 2 describes an example embodiment of the protocol stack for the voice call control when UE is in WLAN mode. When a UE is in WLAN mode, the secure IPsec tunnel is established between the UE and PDG(TTG) for 3GPP/WLAN interworking. It is shown here that TTG and GGSN are separate, but they can be implemented together physically. The GGSN assigns the remote IP address and this is used as inner IP on top of IPsec layer. The protocol between TTG and GGSN is 3GPP standard GTP′. TTG would create the GTP tunnel toward the GGSN and switch the traffic between IPsec tunnel and GTP tunnel. All the traffic is exchanged inside the IPsec tunnel between UE and TTG. Out of IPsec, SIP over UDP is used to carry the voice call control signaling between UE and VCC-AS. When the destination is the CS network entity, VCC-AS sends the signal to MGCF, which changes the SIP signaling to SS7 signaling. In case of IP calls, the VCC-AS sends the SIP signaling directly to the destination.

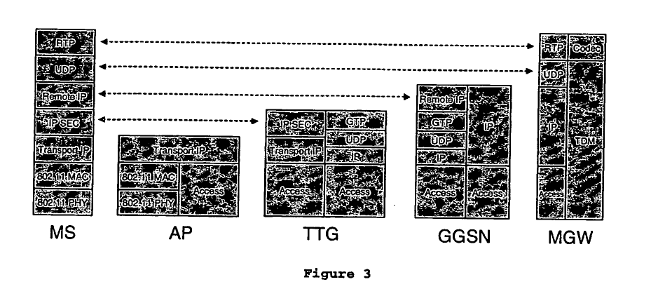

FIG. 3 describes an example embodiment of the protocol stack for the voice call bearer when UE is in WLAN mode. When the call control signaling is completed, MGW sets up the call bearer towards UE. Same as the control signaling, when a UE is in WLAN mode, all the call bearer traffic is transported inside the IPsec tunnel. Out of IPsec, RTP/UDP is used to carry the voice traffic and, if necessary, MGW would convert the data using appropriate codec over TDM. The GGSN may be omitted from the path if PDG is used instead of TTG, where the PDG can directly route the traffic to the MGW without the need of GTP tunnel.

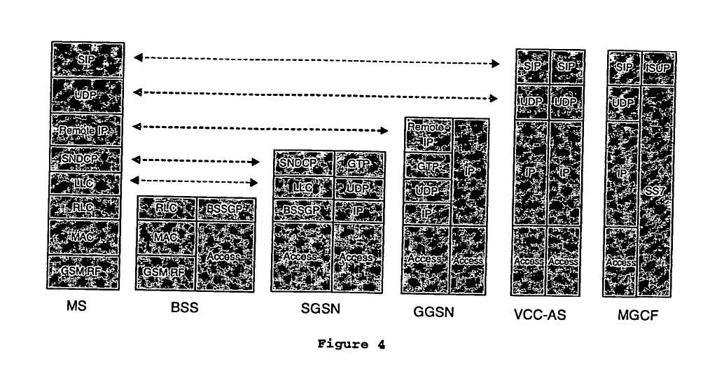

FIG. 4 describes an example embodiment of the protocol stack for the voice call control when UE is in GSM mode. When a UE is in GSM mode, the secure tunnel between UE and TTG is not needed, and all the signaling is exchanged through GSM protocol stack between UE, BSC, SGSN, and GGSN. GGSN is responsible for assigning the remote IP address. The application layer signaling is SIP/UDP as same as when the UE is in WLAN mode. The SIP signaling is delivered to VCC-AS, where it decides to send the traffic to MGCF for conversion or to the destination for IMS call.

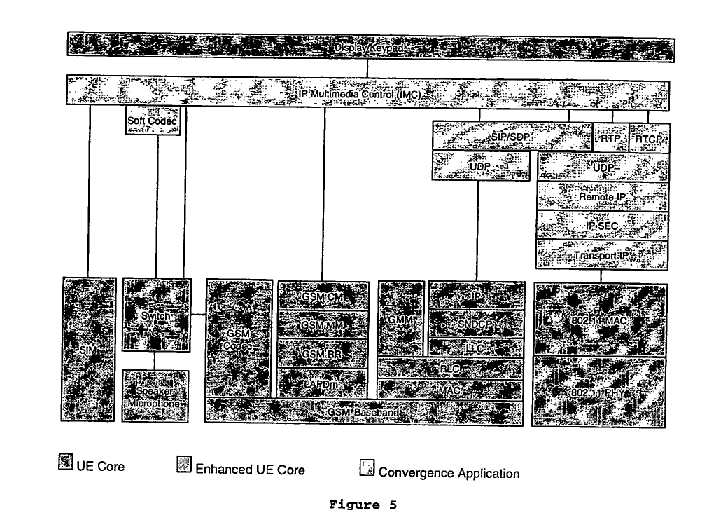

FIG. 5 shows an example logical architecture of a converged UE device consistent with an embodiment of the present innovations. The UE is a standard GSM/GPRS phone integrated with WLAN transport, WLAN interworking capability, SIP endpoint capability with RTP for media transport and RTCP for media QoS management. The UE has a convergence application that presents a unified view to the end-user. The IP Multimedia Control (IMC) represents the application layer software that contains the logic for the unified call handling over the paths enabled through GSM/GPRS and WLAN radios. The IMC uses SIP signaling with the VCC-AS for all call processing. This picture shows the GPRS bearer to carry the SIP signaling while the UE is in GSM/GPRS mode, but it is possible to carry the SIP signaling over other transport mechanism, e.g. USSD or SMS. In case the USSD or SMS is used, the SIP-to-USSD (or SMS) encoding might be required in converged UE.

Even though SIP is used for all the calls, the media for the GSM call is CS while the media for WLAN call is PS. For the WLAN path, it uses the RTP/RTCP for media handling and for the GSM path it uses the regular GSM circuit switched bearer.

The IMC also controls the user experience and therefore needs to have control over MMI. It intercepts all user interaction with the keypad and GUI. In few cases, it may pass the user event un-altered to the GSM stack. (e.g. when the UE is in GSM coverage, the emergency calls could be made directly through the GSM radio.) The GSM codec may not be accessible for external applications such as IMC. In such a case a soft codec is needed for the WLAN call. Using the switch, the IMC controls the stream that is fed to the audio circuit of the phone.

The IMC stores network related information in the permanent memory of the phone. (e.g. the DNS name for the TTG and VCC-AS, etc.) Before IMC can communicate with the VCC-AS, there must be an authenticated and secure IP path from UE to the home network where the VCC-AS resides. The IMC could include such a functionality itself or it could be provided by a stand-alone connection manager. For performing authentication for WLAN registration, the IMC interacts with the SIM.

### EXAMPLES

FIG. 6 shows an example MO call flow to PSTN recipient when UE is in WLAN mode. Before a call is initiated, the UE needs to be authenticated and registered through WLAN. During authentication and/or authorization, the VCC-AS retrieves all the necessary subscriber profile of the user either from HLR (or HSS) or from another 3GPP-WLAN interworking node. It should be noted that the VCC-AS keeps the authentication status of the user through either of these mechanisms. The UE sends periodic SIP registration message to the VCC-AS, which is working as SIP registrar/server, through WLAN radio, so that VCC-AS knows the UE is registered in WLAN domain.

When a UE wants to initiate a call, it would send the SIP Invite to VCC-AS through WLAN radio. The destination number is the actual destination number. For SIP session initiation, the SIP authentication procedure may be needed. This authentication procedure may be optimized and skipped at VCC-AS because the VCC-AS stores the user's authentication status that happened during WLAN authentication. It is the implementation decision whether or not to optimize the SIP authentication. VCC-AS terminates this call leg and initiates another SIP Invite toward MGCF since the destination is PSTN. In other words, the VCC-AS not just relays or proxies the SIP signaling, but it acts as B2B UA, and terminates the first SIP leg from UE and then initiates the second SIP leg toward the destination through MGCF. Since VCC-AS initiates another leg toward the destination, if the user switches the domain from WLAN to GPRS, VCC-AS only switches the leg between UE and VCC-AS from one domain to another domain, while keeping the leg from VCC-AS to the destination unchanged. This makes sure that the call can be continued when the serving domain is changed. MGCF converts the SIP signals to ISUP control messages and sends the message to the called destination party in PSTN. When the ISUP call accept message arrives at MGCF from PSTN, MGCF converts the message to SIP OK message and sends it to VCC-AS. VCC-AS relays the SIP OK message to UE.

After the signaling is over, there are three IP connectivity segments from UE to MGW. First segment is between UE and TTG, and this segment is protected by secure IP tunnel, e.g. IPsec. Second IP segment is between TTG and GGSN, and this segment is the standard GPRS GTP′ interface. After that, the application IP layer is connected between GGSN and MGW. When the PDG is used instead of TTG, the IP part of the call leg would consist of two segments instead of three segments, because the GTP′ is not needed. The PDG would open the IPsec and send the traffic to MGW directly.

As a result, regardless of the number of segments that the IP legs have, the call bearer is composed of two legs, between UE and MGW and between MGW and PSTN destination. The leg between UE and MGW is the IP connection and the call is carried in RTP packets. The call bearer is then transcoded at MGW so that the call is carried over CS bearer toward the destination at PSTN.

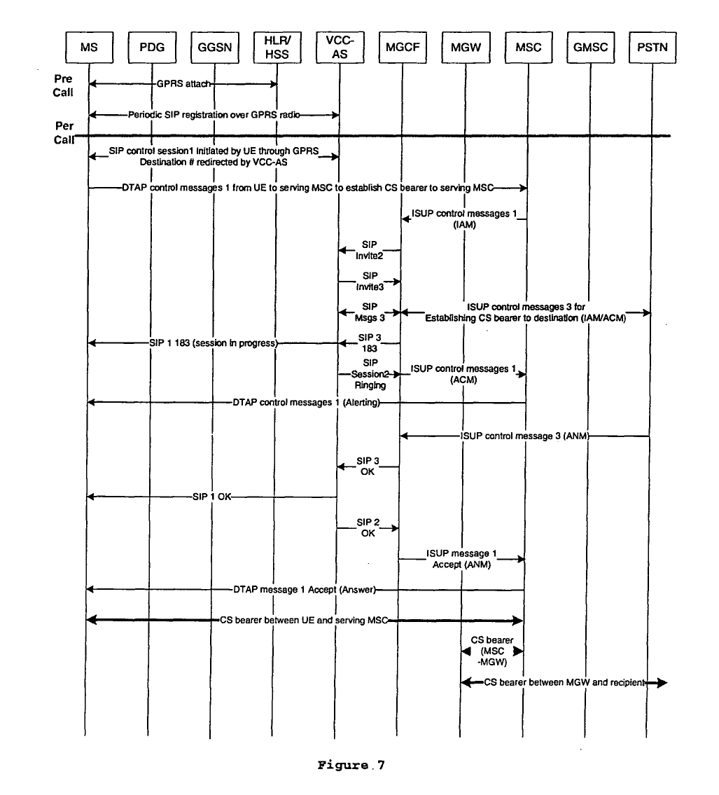

FIG. 7 shows the MO call flow to PSTN recipient when UE is in GSM/GPRS mode. When a UE is in GSM/GPRS mode, the UE attaches itself to GPRS network through standard GPRS procedure. With attach procedure, the GPRS nodes know that the UE is attached to GPRS network and is serviced through GPRS radio. The VCC-AS is working as a SIP server, and the converged UE registers itself to the VCC-AS through GPRS radio. It is important that the UE registers itself to VCC-AS even when it is in GPRS mode, since the VCC-AS should be aware of the UE status. So the UE sends the SIP registration message to VCC-AS indicating that it is registered in GSM and sends the periodic SIP signaling through GPRS radio.

When the UE initiates a call, it is the converged UE that sends the SIP signaling to the VCC-AS. The destination number in the SIP control message indicates the actual destination number. When VCC-AS receives the call, it knows that the UE is registered in GSM network so the call should be initiated from CS part of the UE. The VCC-AS sends the response to the UE with the redirect number of itself, i.e. VCC-AS, instructing the UE to create CS bearer. This SIP signaling is carried over out-of-band signaling. GPRS radio is assumed in this example for illustration.

The converged UE knows that it has to initiate the CS call, and it sends the DTAP call initiation message to the VCC-AS through serving MSC as indicated by SIP response. The serving MSC sends the ISUP message to MGCF and MGCF converts the ISUP message to SIP and sends the message to VCC-AS, which is the destination. Now the first leg of the call signaling is finished from VCC-AS's point of view. Then the VCC-AS initiates another call leg toward the real destination by sending the SIP Invite message to MGCF. The actual destination number should be available from the SIP messages delivered to VCC-AS, either provided by the UE or stored at VCC-AS from the first Invite message. MGCF exchanges the ISUP call control messages with the destination in PSTN, and converts the signal to SIP and sends them to VCC-AS.

When VCC-AS receives the Ringing message from the recipient, it would send this indication to both SIP and ISUP part of the UE. So it sends the SIP signaling message to UE and sends the ISUP signaling message to serving MSC through MGCF, where the serving MSC relays the message to the originating UE. The IMS part of the converged UE would use the SIP ringing message as an indication that the destination is ringing (i.e. the resource has been reserved for this call at the destination), and GSM part of the converged UE would use the DTAP ringing message as an indication that the VCC-AS, as a destination, is ringing (i.e. the resource has been reserved for this call at the VCC-AS).

When the final answer message arrives at the VCC-AS from the PSTN recipient, it sends the SIP OK message to UE to indicate that the call has been successfully answered by the recipient, and sends the DTAP Accepted message to the serving MSC to indicate that the call has been answered by VCC-AS.

After this call signaling, the CS bearer is established between UE and the serving MSC to carry the user voice traffic. The CS bearer is established through UE-serving MSC-MWG-PSTN route. It should be noted that it is converged UE's functionality to handle these two call signaling (one through SIP and one through DTAP) appropriately to ensure that the call is connected through proper access network, i.e. through GSM in this case.

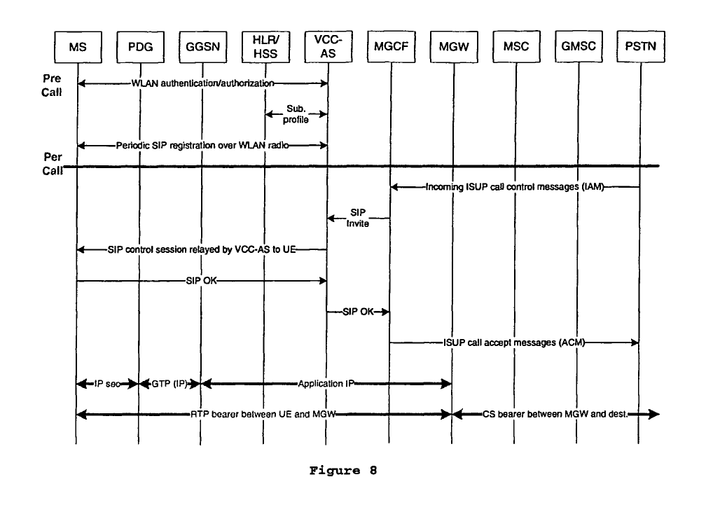

FIG. 8 shows the MT call flow from PSTN originator when UE is in WLAN mode. As in MO case, the user should be authenticated and authorized first to use WLAN radio. Through this process, the UE is registered in VCC-AS and VCC-AS knows that the UE is registered in WLAN mode. The UE sends the periodic SIP registration message to VCC-AS over WLAN radio.

When the call is coming from PSTN to the UE, the IMS routing node would receive the call because the UE is known to be in WLAN domain. The IMS routing node (e.g. serving CSCF) should route the call to VCC-AS through some filtering mechanism. The IMS routing node should convert the signaling from DTAP/IDUP to SIP and send the message to VCC-AS through MGCF. MGCF changes the protocol from DTAP to SIP and sends it to VCC-AS. When VCC-AS receives the SIP control message, it checks and decides that the UE is in WLAN mode and terminates the SIP session and initiates another SIP message to the UE. When UE sends a response to VCC-AS, the VCC-AS sends the response to the originator.

As in MO case, the IP RTP bearer is used between UE and MGW, with two or three IP segments and the CS bearer is used between MGW and originator in PSTN.

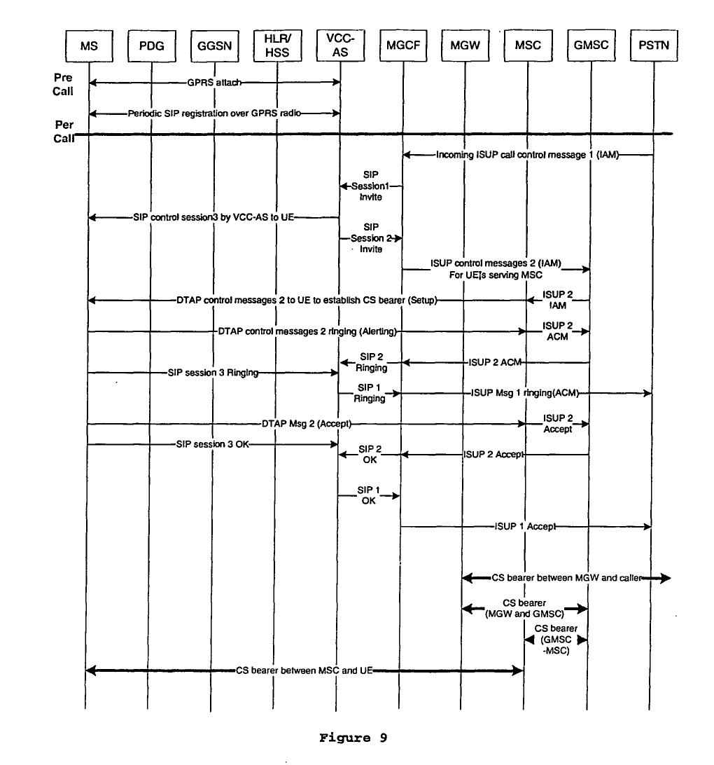

FIG. 9 shows the MT call flow from PSTN originator when UE is in GSM mode. The UE attaches to GPRS and sends SIP registration message to VCC-AS over GPRS radio. When a call arrives at UE's GSM switching node (e.g. serving MSC) from PSTN, MSC sends the call message to VCC-AS through MGCF. Some logic or filtering mechanism would be needed at MSC to route the call to VCC-AS. Since VCC-AS knows that the UE is registered in GSM, it would terminate the SIP session and initiate the CS session toward the UE. VCC-AS sends the SIP control message it received from MGW to UE to indicate that the call has been arrived. The converged UE would not attempt to answer the call because the UE is registered in GSM. The converged UE functionality would decide if it should attempt to answer the call or not. Then VCC-AS initiates the CS call leg toward GMSC through MGCF, where the GMSC would consider the call as MT CS call to the UE. GMSC sends the ISUP control message to the serving MSC and the serving MSC sends the DTAP message to the UE. Another possible approach is that the VCC-AS instructs the UE to initiate the CS call toward VCC-AS, as in the case of MO call. In both cases, VCC-AS would be the anchor point and control the status of the call.

At the UE, if all the necessary resource is reserved and the user is notified (i.e. the phone is ringing), the UE sends the DTAP ringing message to VCC-AS through serving MSC and GMSC. At the same time, the converged UE sends the SIP ringing message to VCC-AS, so that the VCC-AS can use this message as an indication of ringing. Upon receiving the two SIP messages, one directly from UE and one from MGCF, VCC-AS sends the ringing indication to the PSTN originator through MGCF.

When a user answers the call, the converged UE sends both the SIP OK message and DTAP accepted message. When receiving the OK messages, the VCC-AS knows that the user has answered the phone and sends this indication to the PSTN originator.

Now the CS bearer has been established between the PSTN originator and the MGW. The CS bearer is present in PSTN-MGW-GMSC-serving MSC-UE route.

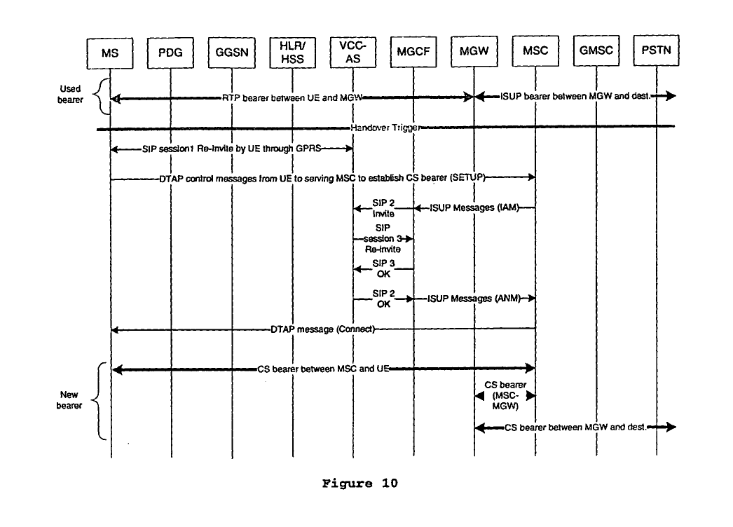

FIG. 10 shows the call flow for the handover from WLAN to GSM when the UE was talking to PSTN. Since the UE was in the WLAN mode, the RTP bearer had been established and used between UE and MGW, and the CS bearer has been established and used between MGW and PSTN.

When there was a need for the handover to GSM (e.g. the UE went out of WLAN coverage and got attached to GPRS), the UE sends the SIP control message to VCC-AS to modify the session information. This SIP message is carried over GPRS radio indicating that the user is registered in GSM mode now. The SIP ‘Re-invite’ may be used for this purpose. This Re-invite message is delivered to VCC-AS, and as for the case where the MO call initiated in GSM cell, VCC-AS provides the re-direct response message to the UE, with the destination number set to itself, i.e. VCC-AS, instructing the UE to create the CS bearer. Then the UE sends the DTAP call control message to the serving MSC, where the call is destined to VCC-AS through MGCF. The VCC-AS decides that this is handover request, and it sends the SIP ‘re-invite’ message to MGCF to modify the call bearer toward the UE. Since only the initiating part of the bearer (i.e. bearer between UE and MGW) is changed, MGCF does not need to take further actions towards the destination except there is a change to end-to-end QoS due to handover. In the case where the end-to-end QoS should be changed, the VCC-AS may also modify the bearer toward the destination. However, the bearer path is not changed. The MGCF reserves the resource between UE and MGW and sends the OK message to VCC-AS. When the VCC-AS receives the OK from MGCF, VCC-AS sends the OK message to the MGCF, where MGCF converts this message to ISUP ANM message and sends the message to serving MSC. MSC sends the DTAP message to UE.

Since only the first call leg is changed and the second call leg, i.e. from VCC-AS to the destination, remains the same, there is no need for alerting process. Once the MGCF finishes the bearer re-assignment, the VCC-AS finishes the handover request and switches the call from WLAN to GSM mode. Now the new CS bearer has been setup in UE-serving MSC-MGW path, and the path between MGW and PSTN is used as before, unchanged, and the voice call is continued through this new CS bearer.

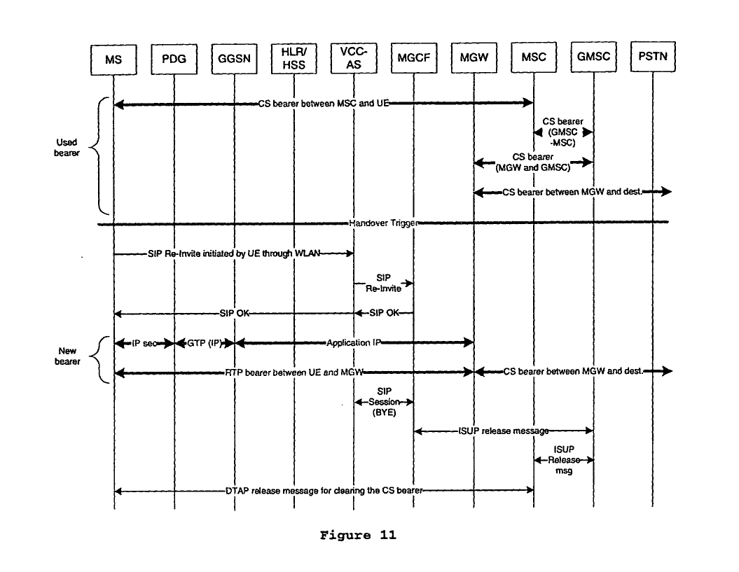

FIG. 11 shows the call flow for the handover from GSM to WLAN when the UE is talking to the PSTN. The call is in progress between the UE and the PSTN through GSM bearer, through UE-serving MSC-GMSC-MGW-PSTN path. The GMSC may be omitted from the path when the call was initiated by the UE toward the PSTN. This example assumes that the PSTN user called the UE and the CS bearer path has been setup through GMSC. When the handover to the WLAN is required (e.g. the UE enters into the WLAN area), then the converged UE sends the SIP ‘re-invite’ control message to the VCC-AS to modify the session. The SIP message is sent over WLAN radio to indicate that the user is registered in WLAN domain now. VCC-AS then sends the SIP ‘re-invite’ message to MGCF to indicate the change of bearer, so that MGCF can control the MGW accordingly. After MGCF assigns a new bearer to MGW, it sends OK to VCC-AS and handover is ready. Same as the WLAN to GSM handover case, the call leg between VCC-AS and the destination remains unchanged unless there is a change of end-to-end QoS due to handover. In case of QoS change, MGCF would modify the call bearer toward the destination, while maintaining the bearer path. VCC-AS sends SIP OK to the UE and the IP RTP bearer is setup in UE-MGW path. The path between MGW and PSTN remains unchanged, providing the CS bearer. The voice call is continued through this new IP bearer and CS bearer.

According to the configuration preference, the GSM call leg can be released after the IP bearer has been setup and the call is handed over to WLAN. For this, VCC-AS sends Release message to the UE through MGCF-GMSC-serving MSC path. Then the UE clears the CS bearer.

According to a disclosed class of innovative embodiments, there is provided: A communication system, comprising: a first access network; a media gateway; and a first node adapted to change at least one bearer between a user equipment and the media gateway, while maintaining an uninterrupted bearer between the media gateway and a source/destination node.

According to a disclosed class of innovative embodiments, there is provided: A method of handing off a wireless voice call between a packet data network and a circuit switched network, comprising the steps of: establishing one or more first call control legs between a user equipment and a first node; establishing one or more second call control legs between the first node and a destination; when the user equipment moves from a first access network to a second access network, establishing one or more third call control legs between the user equipment and the first node via the second access network, and; optionally terminating the one or more first call control legs via the first access network, if desired; wherein the one or more third call legs use a different bearer than the one or more first call legs; and herein SIP is used as a call control signaling for first, second, and third call control legs.

According to a disclosed class of innovative embodiments, there is provided: A method of maintaining a voice call when a user equipment changes access networks, comprising the steps of: registering a user equipment to a first node using access technology associated with either a first packet data access network or second circuit switched access network; handling user equipment originating calls, initiated in a first packet data access network, by terminating SIP signaling from the user equipment and initiating another call control signaling leg toward a destination; handling user equipment originating calls, initiated in a second circuit switched access network, by instructing the user equipment to create a circuit switched bearer associated with the second circuit switched access network, terminating SIP signaling from the user equipment, and initiating another call control signaling leg toward the destination; handling user equipment terminating calls, in the first packet data access network, by terminating an incoming call control signaling leg and initiating SIP signaling toward the user equipment; and

handling user equipment terminating calls, in the second circuit switched access network, by terminating the incoming call control signaling, instructing at least the user equipment to create a circuit switched bearer associated with the second circuit switched access network for circuit switched call leg, and initiating SIP signaling toward the user equipment.

According to a disclosed class of innovative embodiments, there is provided: A method of maintaining a voice call when a user equipment changes access networks, comprising the steps of: detecting that a user equipment has entered a second radio access network and registering the user to a first node through the second access network using SIP signaling; handling the UE's handover request to the second access network; establishing the appropriate bearer for handed over call between the user equipment and a second node via the second access network, while maintaining the call bearer leg between a second node and the other party unchanged; and optionally releasing the previous call bearer leg between the user equipment and a second node via the first access network.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For example, though specific examples of packet data and circuit switched networks are given for illustrative purposes, the innovative concepts described herein are not limited to those particular examples.

Additional general background, which helps to show variations and implementations, may be found in the following publications, all of which are hereby incorporated by reference:

“3G Mobile Networks”, Casera and Narang, McGraw Hill, 2005.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A communication system, comprising:
a first access network;
a media gateway; and
a first node adapted to change at least one bearer between a user equipment and the media gateway, while maintaining an uninterrupted bearer between the media gateway and a source/destination node.

2. The system of claim 1, further comprising user equipment adapted to initiate an SIP session between the user equipment and the first node.

3. The system of claim 1, wherein the first node is adapted to change the at least one bearer between the user equipment and the media gateway when the user equipment moves from the first access network to a second access network.

4. The system of claim 1, wherein at least one bearer between the user equipment and the media gateway is changed from a packet data bearer to a circuit switched bearer or from a circuit switched bearer to a packet data bearer.

5. The system of claim 3, wherein the first access network is a packet data access network and the second access network is a circuit switched access network.

6. The system of claim 3, wherein the first access network is a circuit switched access network and the second access network is a packet data access network.

7. The system of claim 1, wherein the first node is adapted to serve as an anchor for the call signaling; and
wherein the media gateway is adapted to anchor the call bearer between the user equipment and the media gateway, and the call bearer between the media gateway and the source/destination node.

8. The system of claim 1, wherein out-of-band packet signaling over an auxiliary data channel is always used by the first node to anchor the call control signaling, whether the access network is circuit switched access network or packet data access network.

9. The system of claim 8, wherein the out-of-band packet signaling is SIP and the auxiliary data channel is GPRS or US SD.

10. A method of handing off a wireless voice call between a packet data network and a circuit switched network, comprising the steps of:
establishing one or more first call control legs between a user equipment and a first node;
establishing one or more second call control legs between the first node and a destination;
when the user equipment moves from a first access network to a second access network, establishing one or more third call control legs between the user equipment and the first node via the second access network, and;
optionally terminating the one or more first call control legs via the first access network, if desired.
wherein the one or more third call legs use a different bearer than the one or more first call legs; and
wherein SIP is used as a call control signaling for first, second, and third call control legs.

11. The method of claim 10, wherein the bearer of the one or more first call legs is an RTP bearer, and the bearer of the one or more third call legs is an TDM bearer.

12. The method of claim 10, wherein call bearer is anchored at a second node.

13. The method of claim 12, wherein the first node is an application server, the second node is a media gateway.

14. The method of claim 10, herein the first node acts as a B2BUA.

15. The method of claim 10, wherein the bearer of the one or more first call legs is a TDM bearer, and the bearer of the one or more third call legs is a RTP bearer.

16. A method of maintaining a voice call when a user equipment changes access networks, comprising the steps of:
registering a user equipment to a first node using access technology associated with either a first packet data access network or second circuit switched access network;
handling user equipment originating calls, initiated in a first packet data access network, by terminating SIP signaling from the user equipment and initiating another call control signaling leg toward a destination;
handling user equipment originating calls, initiated in a second circuit switched access network, by instructing the user equipment to create a circuit switched bearer associated with the second circuit switched access network, terminating SIP signaling from the user equipment, and initiating another call control signaling leg toward the destination;
handling user equipment terminating calls, in the first packet data access network, by terminating an incoming call control signaling leg and initiating SIP signaling toward the user equipment; and
handling user equipment terminating calls, in the second circuit switched access network, by terminating the incoming call control signaling,
instructing at least the user equipment to create a circuit switched bearer associated with the second circuit switched access network for circuit switched call leg, and initiating SIP signaling toward the user equipment.

17. The method of claim 16, wherein the first packet data access network is WLAN, and the second circuit switched access network is GSM.

18. The method of claim 16, wherein the first node is an application server that handles and anchors call signaling between the user equipment and the destination.

19. The method of claim 16, wherein when the user equipment changes access networks, call signaling continues to be anchored at the first node, while call bearers are anchored at a second node.

20. The method of claim 19, wherein the second node is a media gateway.

21-24. (canceled)
